(19) United States
(12) Patent Application Publication
(10) Pub. No.: US 2010/0291265 A1
(43) Pub. Date: Nov. 18, 2010

(54) BAKING COMPOSITION

(75) Inventors: Janice B. Harte, Bath, MI (US); Megan K. Schwannecke, Grand Rapids, MI (US); Shantanu M. Kelkar, East Lansing, MI (US); Eric T. Birmingham, Ephrata, PA (US); Aileen D. Tanojo, Battle Creek, MI (US); Ashley M. Walters, Amherst, OH (US); Nicole R. Goldman, Walled Lake, MI (US)

Correspondence Address: HOWARD & HOWARD ATTORNEYS PLLC, 450 West Fourth Street, Royal Oak, MI, 48067, US

(73) Assignee: BOARD OF TRUSTEES OF MICHIGAN STATE UNIVERSITY, East Lansing, MI (US)

(21) Appl. No.: 12/782,060

(22) Filed: May 18, 2010

Related U.S. Application Data
(60) Provisional application No. 61/179,118, filed on May 18, 2009.

(51) Int. Cl. A21D 10/00; A21D 10/02; A21D 10/04

(52) U.S. Cl. 426/62; 426/549

(57) ABSTRACT

The baking composition of this invention is substantially free of gluten allergens, nut allergens, egg allergens, and dairy allergens. The baking composition includes a flour component and a binder component and is formed using method that includes the steps of providing each of the flour component and the binder component. These components are combined to form the baking composition. A dough, batter, and baked product are also each formed from the baking composition.

### CROSS-REFERENCE TO RELATED APPLICATION

The subject patent application claims priority to, and all the benefits of, U.S. Provisional Patent Application Ser. No. 61/179,118 which was filed on May 18, 2009, the entire specification of which is expressly incorporated herein by reference as various embodiments but does not limit the instant invention in any way.

### FIELD OF THE INVENTION

The subject invention generally relates to a baking composition and a method of forming the baking composition. More specifically, the subject invention relates to a baking composition that includes less than 2 ppm of wheat allergens, nut allergens, egg allergens, and dairy allergens.

### DESCRIPTION OF THE RELATED ART

As is known in the food industry, there is a growing recognition and awareness of allergens in foods. These allergens affect diets and lifestyles and make an impact on consumer purchasing decisions. According to the U.S. Food and Drug Administration (FDA), there are eight primary categories of allergens (i.e., the “Big Eight”) including wheat, milk, eggs, peanuts, tree nuts, fish, shellfish, and soy allergens. Many of these allergens appear in various baked goods, including cookies and breads, in the form of gluten, dairy proteins, egg whites, albumin, nut powders, fish and shellfish by-products, and soy protein. In fact, it is estimated that at least 6 million people in the United States suffer from some type of food allergy. Relative to children, over 90% of food allergies fall into one or more of the aforementioned eight categories.

Typical baking compositions, and products formed therefrom, include gluten from wheat flour and also include various nut, egg, and dairy products. This is problematic for a growing number of consumers due to potential allergic reactions to these products. For that reason, these consumers tend to rely on expensive specialty products that are typically only available at health food stores and through other specialized distributors. Accordingly, there remains an opportunity to develop a baking composition that is substantially free of wheat, nut, egg, and dairy allergens. There also remains an opportunity to form a product from the baking composition that can be consumed by a wide variety of consumers that have food allergies.

### SUMMARY OF THE INVENTION AND ADVANTAGES

The subject invention provides a baking composition that includes a flour component and a binder component. The baking composition also includes less than 2 parts by weight of each of gluten allergens, nut allergens, egg allergens, and dairy allergens, per one million parts by weight of the baking composition. The baking composition is formed using a method that includes the steps of providing each of the flour component and the binder component and the step of combining the flour component and the binder component to form the baking composition. This invention also provides a dough, a batter, and a baked product that are each formed from the baking composition. The baking composition, dough, batter, and baked product have excellent aroma, appearance, body texture, and flavor while being free of many additional allergens. This increases a market and provides additional variety for consumers.

### DETAILED DESCRIPTION OF A TYPICAL EMBODIMENT

The instant invention provides a baking composition, hereinafter referred to as a “composition.” The composition is substantially free of each of wheat allergens, nut allergens, egg allergens, and dairy allergens. Said differently, the composition includes less than 2 parts by weight of each of the wheat allergens, nut allergens, egg allergens, and dairy allergens, per one million parts by weight of the composition. In one embodiment, the composition includes less than 1 part by weight of each of the aforementioned allergens per one million parts by weight of the composition. In alternative embodiments, the composition is free of one or more of the aforementioned allergens.

In various other embodiments, the composition is substantially free, i.e., includes less than 2 parts by weight, of one or more of seafood allergens, shellfish allergens, and/or soy allergens, per one million parts by weight of the composition. In one embodiment, the composition includes less than 1 part by weight of one or more of seafood allergens, shellfish allergens, and/or soy allergens, per one million parts by weight of the composition. In alternative embodiments, the composition is free of one or more of the seafood allergens, shellfish allergens, and/or soy allergens. In still other embodiments, the composition includes less than 2 parts by weight of each of “Big Eight” food allergens, i.e., each of the wheat allergens, nut allergens, egg allergens, dairy allergens, seafood allergens, shellfish allergens, and soy allergens, per one million parts by weight of the composition. It is also contemplated that the composition may be free of each of the “Big Eight” food allergens.

Each of the aforementioned allergens is described in the Food Allergen Labeling & Consumer Protection Act of 2004 (FALCPA). The terminology “wheat allergens” typically includes allergens which are detected by the well known R5-ELISA immunochemical technique. Typically, these allergens include gluten in its native state, prolamins proteins, and gliadin proteins. It is also contemplated that the wheat allergens may include albumins and globulins. Accordingly, the composition is preferably substantially free of (e.g. less than 1 or 2 ppm), or free of, bread crumbs, bulgur, cereal extract, couscous, durum, durum flour, durum wheat, emmer, einkorn, farina, all-purpose flour, cake flour, enriched flour, graham flour, high protein flour, high gluten flour, pastry flour, kamut, semolina, spelt, sprouted wheat, triticale, vital wheat gluten, bran, germ, gluten, grass, malt, starch, whole-wheat berries, and the like, which are known in the art to be typical sources of wheat allergens.

The terminology “nut allergens” typically includes both tree nut allergens and peanut allergens, as are known in the art. Typically, tree nut allergens include the following tree nuts and their byproducts: almonds, Brazil nuts, cashews, chestnuts, filbert/hazelnuts, macadamia nuts, pecans, pine nuts, pistachios, walnuts, and the like. Peanut allergens typically include the well known allergen “Ara h1” and other allergens commonly found in peanuts. Accordingly, the composition is preferably substantially free of (e.g. less than 1 or 2 ppm), or free of, sources of these allergens.

Referring now to the terminology “egg allergens,” this terminology typically includes allergens found in yolks and whites of eggs. These egg allergens typically include the following, and their by-products: albumin, eggnog, globulin, lecithin, lysozyme, mayonnaise, meringue, ovalbumin, ovovitellin, and the like. Accordingly, the composition is preferably substantially free of (e.g. less than 1 or 2 ppm), or free of, sources of these allergens.

The terminology “dairy allergens” typically includes casein proteins which account for approximately 80 percent of proteins in common dairy products such as milks and cheeses. This terminology also typically includes the following dairy products and their by-products: artificial butter flavor, butter fat, butter oil, cheese flavoring, curds, ghee, hydrolysates of casein, milk protein, whey and whey protein, lactalbumin, lactalbumin phosphate, lactoglobulin, lactoferrin, lactulose, nougat, rennet, Recaldent®, Simplesse®, and the like. Accordingly, the composition is preferably substantially free of (e.g. less than 1 or 2 ppm), or free of, sources of these allergens.

The terminology “seafood allergens” typically includes, but is not limited to, the following finned fish and their by-products: anchovies, bass, catfish, cod, flounder, grouper, haddock, hake, herring, mahi mahi, perch, pike, pollock, salmon, scrod, sole, snapper, swordfish, tilapia, trout, tuna, and the like. The terminology “shellfish allergens” typically includes, but is not limited to, the following organisms and their by-products: shrimp, prawns, crab, crawfish, lobster, abalone, clam, cockle, mussel, oyster, octopus, scallop, snail, squid, and the like. In addition, the terminology “soy allergens” typically includes, but is not limited to, edamame, miso, natto, shoyu sauce, soy fiber, flour, grits, nuts and sprouts, soy milk, yogurt, ice cream, cheese, soy protein, soy sauce, tamari, tempeh, textured vegetable proteins, tofu, and the like. Accordingly, the composition is preferably substantially free of (e.g. less than 1 or 2 ppm), or free of, one or more sources of the aforementioned allergens.

Referring back to the composition itself, the composition includes a flour component and a binder component that is described in greater detail below. The flour component may include any flour known in the art so long as the composition is as described above relative to the allergens. Typically, the flour component includes one or more of quinoa, oat, rice, tapioca, millet, amaranth, teff, sorghum, ragi, buckwheat/groats/kasha, coconut, corn, lentils, favas, chickpeas, milo, potato, sweet potato, montina, and combinations thereof. In various embodiments, the flour component includes oat, tapioca, quinoa, and/or rice. The quinoa (flour) may be heated (e.g. roasted) using a roasting process described in greater detail below. Without intending to be bound by any particular theory, it is believed that a blend of oat, rice, and/or quinoa, in addition to cornstarch, may be used to replace wheat flour.

The flour component is typically present in an amount of from 1 to 50, more typically in an amount of from 15 to 40, still more typically in an amount of from 20 to 30, and most typically in an amount of from 25 to 27, parts by weight per 100 parts by weight of the composition. In one embodiment, the composition includes from 14 to 15 parts by weight of oat and/or tapioca flour per 100 parts by weight of the composition. In another embodiment, the composition includes from 6 to 7 parts by weight of quinoa. In still another embodiment, the composition includes from 5 to 6 parts by weight of rice and/or tapioca flour. Of course, it is to be understood that the flour component is not limited to the aforementioned values or ranges and may be present in any value or range of values, both whole and fractional, within those ranges and values described above. Alternatively, the flour component may be present in larger or smaller values and/or range of values than those described above by ±5%, ±10%, ±15%, ±20%, ±25%, ±30%, etc.

Referring now to the binder component, this component may include any binder known in the art so long as the composition is as described above relative to the allergens. The binder component typically includes one or more of xanthan gum, guar gum, locus bean gum, inulin, gum arabic, cellulose, carboxymethylcellulose, methylcellulose such as Methocels that are commercially available from Dow Corning, and combinations thereof. Without intending to be bound by any particular theory, it is believed that xanthan gum improves texture of the composition, aids in refrigeration and free/thaw stability, aids in binding water, and acts as an emulsifier. Xanthan gum may also be used to replace the functionality of gluten (from wheat) and eggs. Xanthan gum may also replace the “stickiness” functionality of gluten that is normally provided by wheat and structure by acting as an emulsifier, which is normally accomplished from proteins in eggs.

The binder component is typically present in an amount of from 0.01 to 0.3, more typically in an amount of from 0.1 to 0.25, still more typically in an amount of from 0.1 to 0.2, and most typically in an amount of from 0.1 to 0.15, parts by weight per 100 parts by weight of the composition. In one embodiment, the composition includes from 0.1 to 0.2 parts by weight of xanthan gum per 100 parts by weight of the composition. Of course, it is to be understood that the binder component is not limited to the aforementioned values or ranges and may be present in any value or range of values, both whole and fractional, within those ranges and values described above. Alternatively, the binder component may be present in larger or smaller values and/or range of values than those described above by ±5%, ±10%, ±15%, ±20%, ±25%, ±30%, etc.

In addition to the flour component and the binder component, the composition may also include one or more additional components including, but not limited to, a fat component, a starch component, a flavoring component, a sweetener component, a chelator component, a leavening component, a preservative component, an antioxidant component, a liquid component, and an additive component. These components are not particularly limited so long as the composition is as described above relative to the allergens.

The fat component typically includes, but is not limited to, one or more of vegetable shortening, vegetable oil, high oleic oils, low trans-fat oils, canola oil, safflower oil, sunflower oil, and combinations thereof. The fat component is typically present in an amount of from 1 to 50, more typically in an amount of from 5 to 25, still more typically in an amount of from 10 to 20, and most typically in an amount of from 13 to 14, parts by weight per 100 parts by weight of the composition. In one embodiment, the composition includes from 10 to 11 parts by weight of vegetable shortening per 100 parts by weight of the composition. In another embodiment, the composition includes from 2 to 3 parts by weight of safflower oil per 100 parts by weight of the composition. Of course, it is to be understood that the fat component is not limited to the aforementioned values or ranges and may be present in any value or range of values, both whole and fractional, within those ranges and values described above. Alternatively, the fat component may be present in larger or smaller values and/or range of values than those described above by ±5%, ±10%, ±15%, ±20%, ±25%, ±30%, etc.

The starch component may include, but is not limited to, one or more of corn starch, arrowroot starch, tapioca starch, potato starch, sweet potato starch, cassava starch, taro flour starch, kudzu starch, manioc starch, sago starch, and combinations thereof. In various embodiments, the starch component includes native and/or chemically modified starches. These native and/or chemically modified starches may be selected for free/thaw stability, acid resistance, mixing stability, high pressure stability, etc. In various embodiments, the starch component is typically present in an amount of from 1 to 25, more typically in an amount of from 2 to 20, still more typically in an amount of from 3 to 10, and most typically in an amount of from 6 to 7, parts by weight per 100 parts by weight of the composition. In one embodiment, cornstarch is present in an amount of from 6 to 7 parts by weight per 100 parts by weight of the composition. Of course, it is to be understood that the starch component is not limited to the aforementioned values or ranges and may be present in any value or range of values, both whole and fractional, within those ranges and values described above. Alternatively, the starch component may be present in larger or smaller values and/or range of values than those described above by ±5%, ±10%, ±15%, ±20%, ±25%, ±30%, etc.

The flavoring component typically includes, but is not limited to, one or more of chocolate flavoring, cocoa flavoring, vanilla flavoring, cookie flavoring, lemon flavoring, cinnamon flavoring, and combinations thereof. In various embodiments, the flavoring component is typically present in an amount of from 0.1 to 3, more typically in an amount of from 0.1 to 2, still more typically in an amount of from 0.1 to 1, and most typically in an amount of from 0.2 to 0.3, parts by weight per 100 parts by weight of the composition. In one embodiment, cookie flavoring is present in an amount of from 0.1 to 0.2 parts by weight per 100 parts by weight of the composition. In another embodiment, vanilla flavoring is present in an amount of from 0.1 to 0.2 parts by weight per 100 parts by weight of the composition. Of course, it is to be understood that the flavoring component is not limited to the aforementioned values or ranges and may be present in any value or range of values, both whole and fractional, within those ranges and values described above. Alternatively, the flavoring component may be present in larger or smaller values and/or range of values than those described above by ±5%, ±10%, ±15%, ±20%, ±25%, ±30%, etc.

Typically, the sweetener component includes, but is not limited to, one or more of white sugar, brown sugar, honey, corn syrup, agave nectar, molasses, Sucralose, acesulfame potassium, aspartame, inulin, and combinations thereof. In various embodiments, the sweetener component is typically present in an amount of from 5 to 75, more typically in an amount of from 10 to 50, still more typically in an amount of from 20 to 40, and most typically in an amount of from 28 to 30, parts by weight per 100 parts by weight of the composition. In one embodiment, white superfine sugar is present in an amount of from 14 to 15 parts by weight per 100 parts by weight of the composition. In another embodiment, brown sugar is present in an amount of from 14 to 15 parts by weight per 100 parts by weight of the composition. In one embodiment, white granulated sugar is replaced with superfine baker's sugar to enhance spread of the composition. Without intending to be bound by any particular theory, it is believed that use of brown sugar and superfine baker's sugar is conducive to formation of a softer, chewier cookie or baked product. Of course, it is to be understood that the sweetener component is not limited to the aforementioned values or ranges and may be present in any value or range of values, both whole and fractional, within those ranges and values described above. Alternatively, the sweetener component may be present in larger or smaller values and/or range of values than those described above by ±5%, ±10%, ±15%, ±20%, ±25%, ±30%, etc.

Referring back to the chelator component, this component typically includes one or more metal chelators such as EDTA, polyphosphates, citric acids, phosphoric acids, and combinations thereof. In various embodiments, the chelator component is typically present in an amount of from 0.05 to 2, more typically in an amount of from 0.05 to 1.5, still more typically in an amount of from 0.05 to 1, and most typically in an amount of from 0.05 to 0.08, parts by weight per 100 parts by weight of the composition. In one embodiment, citric acid is present in an amount of from 0.06 to 0.08 parts by weight per 100 parts by weight of the composition. Of course, it is to be understood that the chelator component is not limited to the aforementioned values or ranges and may be present in any value or range of values, both whole and fractional, within those ranges and values described above. Alternatively, the chelator component may be present in larger or smaller values and/or range of values than those described above by ±5%, ±10%, ±15%, ±20%, ±25%, ±30%, etc.

The leavening component typically includes one or more chemical leaveners such as aluminum compounds, sodium compounds, baking powder, baking soda, cream of tartar, ammonium bicarbonate, sodium bicarbonate, sodium aluminum phosphate, and combinations thereof. The chemical leavener may be encapsulated or non-encapsulated. In one embodiment, the chemical leavener has a particle size of approximately 66 microns. In another embodiment, the chemical leavener has a particle size of about 293 microns. Without intending to be bound by any particular theory, it is believed that a larger particle size may minimize reactions times when baking the composition and also allow for a more uniform composition spread. In still another embodiment, the leavening component includes double action baking powder that includes sodium aluminum sulfate and monocalcium phosphate.

In one embodiment, a low amount of salt and citric acid are used to enhance sweetness and balance the overall flavor of the composition. In another embodiment, sodium bicarbonate and sodium aluminum phosphate are utilized in combination in the leavening component.

In various embodiments, the leavening component is typically present in an amount of from 0.1 to 3, more typically in an amount of from 0.2 to 1.5, still more typically in an amount of from 0.3 to 1, and most typically in an amount of from 0.5 to 0.6, parts by weight per 100 parts by weight of the composition. In one embodiment, sodium bicarbonate is present in the composition in an amount of from 0.2 to 0.3 parts by weight per 100 parts by weight of the composition. In another embodiment, sodium aluminum phosphate is present in an amount of from 0.2 to 0.3 parts by weight per 100 parts by weight of the composition. Of course, it is to be understood that the leavening component is not limited to the aforementioned values or ranges and may be present in any value or range of values, both whole and fractional, within those ranges and values described above. Alternatively, the leavening component may be present in larger or smaller values and/or range of values than those described above by ±5%, ±10%, ±15%, ±20%, ±25%, ±30%, etc.

The preservative component typically includes, but is not limited to, one or more of sodium benzoate, sorbic acid, sodium propionate, potassium sorbate, and combinations thereof. In one embodiment, the preservative component includes encapsulated sorbic acid. In various other embodiments, the preservative component is typically present in an amount of from 0.01 to 3, more typically in an amount of from 0.02 to 1.5, still more typically in an amount of from 0.02 to 1, and most typically in an amount of from 0.02 to 0.03, parts by weight per 100 parts by weight of the composition. In one embodiment, the composition include from 0.02 to 0.03 parts by weight of sodium benzoate per 100 parts by weight of the composition. Sodium benzoate is bacteriostatic and fungistatic and therefore typically utilized in the preservative component. Of course, it is to be understood that the preservative component is not limited to the aforementioned values or ranges and may be present in any value or range of values, both whole and fractional, within those ranges and values described above. Alternatively, the preservative component may be present in larger or smaller values and/or range of values than those described above by ±5%, ±10%, ±15%, ±20%, ±25%, ±30%, etc.

The antioxidant component typically includes, but is not limited to, one or more of rosemary, thyme, sage, lemon balm, alpha tocopherols, BHT, BHA, and combinations thereof. In various embodiments, the antioxidant component is typically present in an amount of from 0.1 to 3, more typically in an amount of from 0.1 to 1.5, still more typically in an amount of from 0.1 to 1, and most typically in an amount of from 0.1 to 0.2, parts by weight per 100 parts by weight of the composition. In other embodiments, one or more alphatocopherols are present in an amount of from 0.1 to 0.2 parts by weight per 100 parts by weight of the composition. Alpha tocopherols are typically utilized to inhibit oxidation and to delay development of off flavors in the composition. Of course, it is to be understood that the antioxidant component is not limited to the aforementioned values or ranges and may be present in any value or range of values, both whole and fractional, within those ranges and values described above. Alternatively, the antioxidant component may be present in larger or smaller values and/or range of values than those described above by ±5%, ±10%, ±15%, ±20%, ±25%, ±30%, etc.

Referring now to the liquid component, this component typically includes water but may include one or more other liquids known in the baking and cooking arts such as syrups, soy milk, etc. In various embodiments, water is typically present in an amount of from 10 to 50, more typically in an amount of from 12 to 20, still more typically in an amount of from 12 to 15, and most typically in an amount of from 14 to 15, parts by weight per 100 parts by weight of the composition. Of course, it is to be understood that the liquid component is not limited to the aforementioned values or ranges and may be present in any value or range of values, both whole and fractional, within those ranges and values described above. Alternatively, the liquid component may be present in larger or smaller values and/or range of values than those described above by ±5%, ±10%, ±15%, ±20%, ±25%, ±30%, etc.

The additive component typically includes, but is not limited to, one or more of chocolate chips, cocoa powder, caramel chips, soy free derivatives thereof, liquid and powdered flavorings, and combinations thereof. Alternatively, the additive component may include a salt. In one embodiment, semi-sweet dark chocolate chips that do not contain lecithin or cows milk are utilized. In various embodiments, the additive component is typically present in an amount of from 0.5 to 25, more typically in an amount of from 1 to 20, still more typically in an amount of from 5 to 20, and most typically in an amount of from 5 to 15, parts by weight per 100 parts by weight of the composition. In one embodiment, soy free chocolate chips are present in the composition in an amount of from 10 to 11 parts by weight per 100 parts by weight of the composition. Of course, it is to be understood that the additive component is not limited to the aforementioned values or ranges and may be present in any value or range of values, both whole and fractional, within those ranges and values described above. Alternatively, the additive component may be present in larger or smaller values and/or range of values than those described above by ±5%, ±10%, ±15%, ±20%, ±25%, ±30%, etc.

In various embodiments, the composition includes each of the flour, binder, fat, starch, flavoring, sweetener, chelator, leavening, preservative, antioxidant, liquid, and additive components. In these embodiments, the flour component typically includes oat and/or tapioca flour, quinoa flour, rice and/or tapioca flour. Also in these embodiments, the starch component typically includes corn starch. Furthermore, the additive component typically includes salt and soy free chocolate chips, the binder component typically includes xanthan gum, the fat component typically includes vegetable shortening and high oleic safflower oil, the flavoring component typically includes cookie flavoring and vanilla flavoring, and the sweetener component typically includes white superfine sugar and brown sugar. Also in this embodiment, the chelator component typically includes citric acid, the leavening component typically includes sodium bicarbonate and sodium aluminum phosphate, the preservative component typically includes sodium benzoate, the antioxidant component typically includes alpha tocopherols, and the liquid component typically includes water.

The composition may be formed in any proportion and in any batch size. In one embodiment, the composition is laboratory or consumer sized and typically has a weight of less than 10, more typically less than 5, and most typically less than 3, pounds. Alternatively, the composition may be production sized and have a weight of greater than 10 pounds. In various embodiments, the composition has a weight of greater than 10, greater than 25, greater than 50, greater than 100, greater than 250, greater than 500, greater than 1,000, greater than 1,500, or greater than 2,000 pounds. Of course, it is to be understood that the proportions, size, weight, etc. of the composition is not limited to the aforementioned values or ranges and may any value or range of values, both whole and fractional, within those ranges and values described above. Alternatively, the proportions, size, weight, etc. of the composition may be larger or smaller than those values and/or range of values described above by ±5%, ±10%, ±15%, ±20%, ±25%, ±30%, etc.

In one embodiment, the composition is production sized and has a weight of from about 1500 to about 2100 pounds. In this embodiment, the composition includes from approximately 478 to 554 pounds of the flour component, approximately 2.5 to 3 pounds of the binder component, approximately 234 to 273 pounds of the fat component, approximately 111 to 130 pounds of the starch component, approximately 10 to 12 pounds of the leavening component, approximately 189 to 201 pounds of the additive component, approximately 5 to 6 pounds of the flavoring component, approximately 507 to 592 pounds of the sweetener component, approximately 1 to 2 pounds of the chelating component, approximately 2 to 3 pounds of the antioxidant component, approximately 0.4 to 0.6 pounds of the preservative component, and approximately 250 to 300 pounds of the liquid component. Alternatively, the weight of the composition may be larger or smaller than those values and/or range of values described above by ±5%, ±10%, ±15%, ±20%, ±25%, ±30%, etc.

In one embodiment, the composition is as follows wherein each value is set forth as an approximate percentage (%) of a total of the composition:

| | |
|---|---|
| Oat and/or Tapioca Flour | 14.07 |
| Quinoa Flour | 6.7 |
| Rice and/or Tapioca Flour | 5.6 |
| Corn starch | 6.2 |
| Salt | 0.42 |
| Xanthan gum | 0.14 |
| Shortening | 10.21 |
| High Oleic Safflower Oil | 2.81 |
| Natural Cookie Flavoring | 0.14 |
| Vanilla Flavoring | 0.14 |
| White Superfine Sugar | 14.1 |
| Brown Sugar | 14.1 |
| Soy Free Chocolate Chips | 10.5 |
| Citric Acid | 0.07 |
| Sodium Bicarbonate | 0.28 |
| Sodium Aluminum | 0.28 |
| Phosphate | |
| Sodium Benzoate | 0.025 |
| Alpha Tocopherols | 0.14 |
| Water | 14.075 |
| Total % | 100 |

In other embodiments, the composition includes one or more of the same components described immediately above in amounts and/or ranges of amounts by ±5%, ±10%, ±15%, ±20%, ±25%, ±30%, etc. In still other embodiments, the composition includes, consists essentially of, or consists of: oat flour, water, brown sugar, superfine sugar, dark chocolate chips (evaporated cane juice, chocolate liquor, cocoa butter), shortening (canola oil, partially hydrogenated cottonseed oil, citric acid [as a preservative]), whole quinoa flour, cornstarch, brown rice flour, safflower oil, salt, vanilla extract, sodium aluminum phosphate (leavening), sodium bicarbonate (leavening), xanthan gum, alpha tocopherols, and sodium benzoate.

Without intending to be bound or limited in any way, it is believed that, in various non-limiting embodiments described by the terminology “consisting essentially of”, the basic and novel characteristics of the composition include one or more of the components and/or ingredients described immediately above. In one embodiment, the terminology “consisting essentially of” excludes one or more of any of the “Big Eight” allergens described above, one or more of any other allergens well known in the art, and/or one or more of any components that would negatively affect the ability of the composition to be used to form a batter, dough, baked product, etc.

In additional embodiments, the composition includes the following approximate weights (lbs) of the flour, binder, fat, leavening, flavoring, and sweetener components:

| | Additional | Additional |
|---|---|---|
| | Embodiment 1 | Embodiment 2 |
| Flour Component | 475 | 554 |
| Binder Component | 2.5 | 2.9 |
| Fat Component | 234 | 273 |
| Leavening Component | 10 | 11.8 |
| Flavoring Component | 5 | 5.9 |
| Sweetener Component | 508 | 592.2 |

In still other embodiments, the composition is as follows wherein each value set forth below is an approximate weight in pounds (lbs):

| | | | | |
|---|---|---|---|---|
| Oat and/or Tapioca Flour | 211 | 253 | 281 | 295 |
| Quinoa Flour | 101 | 121 | 134 | 141 |
| Rice and/or Tapioca Flour | 84 | 101 | 112 | 118 |
| Corn starch | 93 | 112 | 124 | 130 |
| Salt | 6.3 | 7.6 | 8.4 | 8.8 |
| Xanthan gum | 2.1 | 2.5 | 2.8 | 2.9 |
| Shortening | 153 | 184 | 204 | 214 |
| High Oleic Safflower Oil | 42 | 51 | 56 | 59 |
| Natural Cookie Flavoring | 2.1 | 2.5 | 2.8 | 2.9 |
| Vanilla Flavoring | 2.1 | 2.5 | 2.8 | 2.9 |
| White Superfine Sugar | 212 | 254 | 282 | 296. |
| Brown Sugar | 212 | 254 | 282 | 296. |
| Soy Free Chocolate Chips | 158 | 189 | 210 | 221 |
| Citric Acid | 1.05 | 1.26 | 1.4 | 1.47 |
| Sodium Bicarbonate | 4.2 | 5 | 5.6 | 5.9 |
| Sodium Aluminum | 4.2 | 5.04 | 5.6 | 5.9 |
| Phosphate | | | | |
| Sodium Benzoate | 0.38 | 0.45 | 0.5 | 0.53 |
| Alpha Tocopherols | 2.1 | 2.5 | 2.8 | 2.9 |
| Water | 211 | 253 | 282 | 296 |
| Total Weight | 1500 | 1800 | 2000 | 2100 |

Just as described above, it is also contemplated that the composition may include any one or more of the aforementioned components/ingredients in a weight percent that is different from the aforementioned amount by ±5%, ±10%, ±15%, ±20%, ±25%, ±30%, etc.

In another embodiment, the composition has a fat to sugar ratio of from 0.4:0.9 to 0.5:1.1. In still another embodiment, the composition has a fat to sugar ratio of about 0.46:1. In one alternative embodiment, the composition has a fat to water ratio of from 1:1.1 to 1.3:0.9. In another alternative embodiment, the composition has a fat to water ratio of about 1.2:1. In still another embodiment, the composition has an oil to fat ratio of from 0.9:4 to 1.1:3.2. In an alternative embodiment, the composition has an oil to fat ratio of about 1:3.6. In this embodiment, a combination of Safflower oil (flavorless and colorless) and selected shortening (canola oil and partially hydrogenated cottonseed oil) may be used.

In one embodiment, a sugar to fat ratios of 0.46:1 is utilized simultaneously with a fat to water ratio of 1.2:1. In this embodiment, the fat includes a mixture of shortening and safflower oil. The safflower oil is typically used in this embodiment to promote initial spread while the shortening melts at a higher temperature during baking. The shortening typically used in this embodiment includes a combination of canola and partially hydrogenated cottonseed oils that are low in saturated fat and free of trans-fat. Without intending to be bound by any particular theory, it is believed that this combination of fats mimics spread characteristics of butter but is dairy-free, trans-fat free, and low in saturated fat. Just as above, it is to be understood that the aforementioned ratios of fat to sugar, fat to water, sugar to fat, etc. are not limited to the aforementioned values or ranges and may be further defined as any value or range or ratio of values, both whole and fractional, within those ranges and values described above. Alternatively, the aforementioned ratios may be larger or smaller than those described above by ±5%, ±10%, ±15%, ±20%, ±25%, ±30%, etc.

The composition typically includes less than 5, more typically less than 3, and most typically less than 1, gram of saturated fat per Reference Amount Customarily Consumed (RACC), as defined by the Food and Drug Administration (FDA). The composition also typically includes less than 25, more typically less than 20, and most typically less than 15, percent of total calories originating from saturated fats. In various embodiments, the composition typically includes less than 1.5, more typically less than 1.0, and most typically less than 0.5 grams of trans fatty acids per RACC and per labeled serving. In other embodiments, the composition includes than 1.5, more typically less than 1, and most typically less than 0.5, milligrams of cholesterol per RACC. In still other embodiments, the composition includes less than 300, more typically less than 200, and most typically less than 140, milligrams of sodium per RACC. In addition, it is to be understood that the aforementioned values of saturated fat, cholesterol, etc. are not limited to the aforementioned values or ranges and may be any value or range of values, both whole and fractional, within those ranges and values described above. Alternatively, the aforementioned values and/or range of values may be larger or smaller than those described above by ±5%, ±10%, ±15%, ±20%, ±25%, ±30%, etc.

### Formation of a Dough:

The composition of this invention may be further defined as a wet mix and include the liquid component (e.g. water) or may be further defined as a dry mix, as generally known in the art. Alternatively, the composition may be further defined as a dough. The dough is typically a cookie dough and typically includes at least the flour component, the binder component, and the liquid component (e.g. water). In one embodiment, the dough includes at least from 35 to 45 parts by weight of the flour component, 0.1 to 3 parts by weight of the binder component, and at least 10 parts by weight of water, per 100 parts by weight of the dough. Of course, the dough is not limited to this embodiment.

The dough may be of any size and shape but typically is formed as a block. The dough may be scored or un-scored but is typically scored. In various commercial embodiments, the dough typically has a width of from 3 to 10 feet, more typically of from 5 to 8, and most typically of from 6 to 8, feet. In other embodiments, the dough typically has a length of from 3 to 10 feet, more typically of from 5 to 8, and most typically of from 6 to 8, feet. In still other embodiments, the dough typically has a height (i.e., thickness) of from 2 to 6, more typically of from 3 to 5, and most typically of from 3 to 4, feet.

In various consumer embodiments, the dough typically has a width of from 0.1 to 3 feet and more typically of from 0.5 to 1 feet. In other embodiments, the dough typically has a length of from 0.1 to 3 feet and more typically of from 0.5 to 1 feet. In still other embodiments, the dough typically has a height (i.e., thickness) of from 0.1 to 6, more typically of from 1 to 4, and most typically of from 1 to 4, inches. In one embodiment, the dough is pre-scored and has a width of approximately 6 inches, a length of about 5 inches, and a height of about 1 inch. In other embodiments, the dough typically has a weight of less than 10, more typically less than 5, and most typically less than 3, pounds. Alternatively, the dough may have a weight of greater than 10 pounds. In various embodiments, the dough has a weight of greater than 10, greater than 25, greater than 50, greater than 100, greater than 250, greater than 500, greater than 1,000, greater than 1,500, of about 1,970 pounds, or greater than 2,000 pounds. In one embodiment, the dough has a weight of from 100 grams to 10 pounds. In another embodiment, the dough has a weight of from 300 to 500 grams, and a size of about 6.25×4.75 inches. In still another embodiment, the dough has dimensions of about 6.25″×4.75″ and a weight of about 480 grams. Just as above, it is to be understood that the values used to described various aspects of the dough (e.g. dimensions, weight, weight percents, etc) are not limited to the aforementioned values or ranges and may any value or range of values, both whole and fractional, within those ranges and values described above. Alternatively, the values may be larger or smaller than those described above by ±5%, ±10%, ±15%, ±20%, ±25%, ±30%, etc.

### Formation of a Batter:

In one embodiment, the composition is further defined as a batter. The batter typically includes at least the flour component, the binder component, and the liquid component (e.g. water). In one embodiment, the batter includes at least from 35 to 45 parts by weight of the flour component, 0.1 to 3 parts by weight of the binder component, and at least 20 parts by weight of water, per 100 parts by weight of the batter. Of course, the batter is not limited to this embodiment. Again, it is to be understood that the values used to described various aspects of the batter (e.g. dimensions, weight, weight percents, etc) are not limited to the aforementioned values or ranges and may any value or range of values, both whole and fractional, within those ranges and values described above. Alternatively, the values may be larger or smaller than those described above by ±5%, ±10%, ±15%, ±20%, ±25%, ±30%, etc.

### Method of Forming the Baking Composition:

In addition to the composition described above, the instant invention also provides a method of forming the composition. Typically, the composition is formed in an environment that is free of the aforementioned allergens. However, the environment is not limited in such a manner so long as the composition is as defined above relative to each of wheat allergens, nut allergens, egg allergens, and dairy allergens. The method includes the steps of providing the flour component and providing the binder component. The method also includes the step of combining the flour component and the binder component to form the composition. An entire amount of the flour component, or any smaller portion thereof, may be combined with an entire amount of the binder component or any smaller portion thereof. In other words, amounts of the flour component may be added to the binder components in a batch, semi-batch, or continuous process. Typically, the entire amount of the flour component is combined with the entire amount of the binder component.

In various embodiments, the method includes the step(s) of adding one or more of the starch, fat, flavoring, sweetener, chelator, leavening, preservative, antioxidant, liquid, and/or additive components to the flour component, to the binder component, to the composition after the flour and binder components are combined, or to all of the above. Just as above, an entire amount, or any smaller portion thereof, of any of the aforementioned components may be combined with an entire amount, or any smaller portion thereof, of the flour component, the binder component, and/or the composition. In other words, amounts of one or more of the components may be added to the flour component, the binder component, and/or the composition in a batch, semi-batch, or continuous process.

In one embodiment, the method includes the step of combining the flour component, the binder component, and the liquid component (e.g. water) to form the dough. Typically, the dough is formed in an environment that is free of the aforementioned allergens. However, the environment is not limited in such a manner so long as the dough is as defined above relative to each of wheat allergens, nut allergens, egg allergens, and dairy allergens. In an alternative embodiment, the method includes the step of combining the flour component, the binder component, and the liquid component (e.g. water) to form the batter. The flour component and the binder component, in addition to any other components, may be combined or mixed using any method known in the art. Typically, the flour component and the binder component are combined using a sigma blade mixer but can be combined using any mixer known in the art.

In one embodiment, a sigma blade mixer is used to prepare a dough that is soft and/or tender. Typically, the sigma blade mixer accommodates a maximum batch size of about 2300 lbs and has a variable-speed motor for high and low speed mixing. Sigma shaped arms typically fold the components into the dough as it develops. In one embodiment, vegetable oil and α-tocopherol are incorporated. Granulated white sugar and brown sugar may then be added to the sigma blade mixer for creaming. Once the sugars and shortening are creamed, dry components, e.g. oat, rice and roasted quinoa flour, leavening and xanthan gum, may be added. A solution of citric acid, vanilla extract, cookie flavor and sodium benzoate in water may also then be added. Typically, a consistent dough that is soft and suitable for sheeting is formed. Also in this embodiment, chocolate chips are added and blended into the dough.

In other embodiments, the method includes the step of incorporating the sweetener component into the binder component to form a mixture. This step is commonly known in the art as “creaming.” In these embodiments, the sweetener component is typically incorporated into the binder component prior to the step of combining the flour component and the binder component. After the mixture is formed, the flour component is typically combined with the binder component (i.e., the mixture). Just as above, the flour component may be added to the binder component in a batch, semi-batch, or continuous process. In these embodiments, any of the fat, starch, flavoring, sweetener, chelator, leavening, preservative, antioxidant, and/or additive components which are dry may be added to the flour component either before or after combination with the binder component. After dry components are combined, water is typically added to the composition to form the dough or batter.

In another embodiment, the binder component is combined with the antioxidant component prior to the step of combining the flour component and the binder component. In yet another embodiment, a solution of the chelating component, the flavoring component, the preservative component, and the liquid component are combined and added to the composition.

In one embodiment, the flour component includes quinoa flour and the method further includes the step of heating or roasting the quinoa flour. As is known in the art, quinoa is a seed that can be milled into flour as used as a cereal crop. The step of heating the quinoa typically minimizes a bitter flavor thought to originate from the presence of saponins on the outside of the quinoa. In one embodiment, the method includes the step of grinding and/or immersing the quinoa in water, as is known in the art to further minimize the bitter flavor and to minimize nutrient loss.

The quinoa flour utilized in this invention typically includes particles that have a thickness of from 1 to 3 mm. Without intending to be bound by any particular theory, it is believed that utilizing particles having a thickness of less than 1 mm results in over-roasting or burning. Similarly, it is believed that utilizing particles having a thickness of greater than 3 mm results in incomplete roasting. Typically, before heating, the quinoa has a grassy smell and a pale color. After heating, the quinoa typically has a nutty smell and a golden color.

In one embodiment, the quinoa flour includes particles having a thickness of from 1 to 3 mm and the step of roasting occurs for a time of from 10 to 25 minutes at a temperature of from 250 to 350° F. Alternatively, the quinoa flour may be roasted at a temperature of from 250 to 325 or at a temperature of from 275 to 310° F. The quinoa flour may also be roasted for a time of from 1 to 30 or for a time of from 11 to 14, minutes. In one embodiment, the quinoa flour is roasted for a time of from 20 to 25 minutes at a temperature of from 250° F. to 275° F. In another embodiment, the quinoa flour is roasted for a time of from 11 to 14 minutes at a temperature of about 300° F.

The method may also include the step of cooling the composition. The step of cooling may be further defined as refrigerating and/or freezing the composition. The composition may be refrigerated at a temperature of from 33° F. to 38° F. The composition may also, or alternatively, be frozen at a temperature of less than 0° F., more typically at a temperature of less than −10° F., and most typically at a temperature of about −20° F. The composition is typically frozen for a time of from 1 to 60, more typically for a time of from 10 to 30, even more typically for a time of from 15 to 25, and most typically for a time of from 18 to 22, minutes. In various embodiments, the composition is formed in a time of less than 4, 3, 2, 1, or ½ hours to reduce a chance of microbial growth. The composition may be formed at any temperature but is typically formed at room temperature or below.

After formation, the dough may be fed to a hopper of an extruder (e.g. a wire-cut extruder) and extruded through a die and through a frame that includes a sharpened edge or knife. The sharpened edge typically cuts the dough into slabs. Subsequently, a stamping machine may imprint a grid on a surface of the dough and portion the dough into pieces. More specifically, the wire-cut extruder may include a hopper over a system of three rollers wherein the rollers extrude the dough through a rectangular die and a frame that bears the sharpened knife moving across an outer surface of the die. The wire cut extruder may form 480-gram rectangular slabs of dough. The stamping machine may then imprint a 2 mm deep grid on a surface of the dough thus portioning the dough into 24 pieces of approximately 20 grams each. Subsequently, medium chain triglycerides (allergen free, non-GMO) may be brushed onto conveyor belts and the sharpened knife to prevent dough build up.

After the dough is formed, the dough may be advanced along the conveyor belts towards a pick-and-place system, e.g. a robotic pick and place system. The pick and place system may load the dough into trays of paperboard laminated with a polymeric film via use of vacuum gripping. The polymeric film is typically used to minimize absorption of moisture from the dough by the tray. Without intending to be bound by any particular theory, it is believed that the tray gives the dough more body and helps maintain shape integrity during shipping and use. After the dough is loaded into the trays, the trays are then typically conveyed to a horizontal form fill seal system and loaded into packages or pouches, as described in greater detail below.

In one embodiment, the pouches are conveyed through a spiral freezer set at a temperature of about −20° F. for 20 minutes. The pouches may then be end-loaded into one or more corrugated board regular slotted cartons (RSC) for shipping. The cartons are typically sealed and palletized and sent to frozen storage to prolong shelf life before distribution in temperature-controlled vehicles. Just as above, it is to be understood that the values used to described various aspects of the method of forming the composition, dough, and/or batter (e.g. times, temperatures, dimensions, etc) are not limited to the aforementioned values or ranges and may any value or range of values, both whole and fractional, within those ranges and values described above. Alternatively, the values may be larger or smaller than those described above by ±5%, ±10%, ±15%, ±20%, ±25%, ±30%, etc.

### Baked or Cooked Products:

The composition may be used to form a baked or cooked product including, but not limited to, cookies, cakes, breads, biscuits, cupcakes, pastries, pies, tarts, buns, brownies, blondies, pancakes, waffles, crackers, breadsticks, pitas, quiches, muffins, croissants, danishes, scones, turnovers, bars, strudels, and the like. The product may be of any size and shape. In one embodiment, the product is further defined as a cookie. The cookie typically has a diameter of from 0.5 to 6, more typically of from 0.5 to 3, and most typically of from 1 to 3, inches. The cookie also typically has a height (i.e., thickness) of from 2 mm to 0.5 inches, more typically of from 0.1 inches to 0.5 inches, and most typically of from 0.25 inches to 0.5 inches. In one embodiment the cookie has a diameter of from 2 to 2.25 inches and a thickness of about 0.5 inches. In another embodiment the cookie has a diameter of from 2 to 3 inches and a thickness of from 0.1 to 1 inch. Of course, the instant invention is not limited to these dimensions. Again, it is to be understood that the values used to described various aspects of the baked or cooked products are not limited to the aforementioned values or ranges and may any value or range of values, both whole and fractional, within those ranges and values described above. Alternatively, the values may be larger or smaller than those described above by ±5%, ±10%, ±15%, ±20%, ±25%, ±30%, etc.

In one embodiment, the baked product includes oat flour to optimize the structure of the baked product and to contribute a familiar flavor. Cornstarch may also be incorporated as a gluten-free, low cost binder that reduces the concentration of proteins to tenderize the baked product without excessive spreading.

Method of Forming the Cooked and/or Baked Product:

The instant invention also provides a method of forming the product from the composition. The method includes the steps of providing the composition and heating the composition. In one embodiment, the step of providing the composition is further defined as providing an approximately 1×1 inch portion of the composition. Of course, the method is not limited to these dimensions. In other embodiments, the step of heating the composition is further defined as heating the composition to temperatures of at least 275° F., of at least 300° F., of at least 325° F., of at least 375° F., or of at least 400° F. In still other embodiments, the composition is heated for a time of at least 5 minutes, at least 10 minutes, or at least 15 minutes. Alternatively, the composition may be heated for a time of from 1 to 20 minutes, from 5 to 15 minutes, from 5 to 10 minutes, from 10 to 15 minutes, or from 12 to 14 minutes. The step of heating may be further defined as baking the composition. Just as above, it is to be understood that the values used to describe various aspects of the aforementioned method are not limited to the aforementioned values or ranges and may any value or range of values, both whole and fractional, within those ranges and values described above. Alternatively, the values may be larger or smaller than those described above by ±5%, ±10%, ±15%, ±20%, ±25%, ±30%, etc.

Package for the Composition, Dough, Batter, and/or Product:

In addition to the above, the instant invention also provides a package for the composition, dough, batter, and/or product. The package may be any known in the art but is typically further defined as a film, container, box, carton, bag, envelope, drum, can, bottle, or the like. In one embodiment, the package is a “clamshell” container, as is known by those of skill in the art. In another embodiment, the package is a bag. In a further embodiment, the package is a heat shrinkable film. In still a further embodiment, the package is an envelope. Alternatively, the package may be further defined as a re-sealable bag. In another embodiment, the package is further defined as a container that has a removable lid. In still another embodiment, the package is vacuum sealed or vacuum sealable.

In one embodiment, the package is a unitary structure, i.e., a “one-piece” structure. In an alternative embodiment, the package is a multi-layer film. The package may be sealed to itself or, alternatively, may be sealable to itself or sealable a substrate by any means known in the art including, but not limited to, manual sealing (e.g. with a fastener, clip, or string) and/or chemical sealing (e.g. with melt-adhesion or chemical fusion). Typically, the substrate to which the package may be sealed is further defined as a food-grade film or food-grade container, as is known in the art of food preparation and packaging. In one embodiment, the package is further defined as a pre-printed multilayer laminate that forms a pouch. In one embodiment, the pouch has an approximate size of 5.5×8.75 inches.

Alternatively the package may be a two-piece structure including a top portion and a bottom portion that are typically disposed opposite each other and define a cavity therebetween. Both the top and bottom portions may include one or more layers. Typically, the top portion defines a first periphery while the bottom portion defines a second periphery. In one embodiment, an entirety of the first periphery is disposed in contact with an entirety of the second periphery. In another embodiment, the entirety of the first periphery is sealed with the entirety of the second periphery. The first and second peripheries may be sealed by any means known in the art including both physical and chemical means, as described above. In one embodiment, the first and second peripheries are sealed using mechanical interlocking teeth, such as in a Ziploc® bag. In another embodiment, the first and second peripheries are sealed using a mechanical press fit, such as in a Tupperware® container. In alternative embodiments, the first and second peripheries are mechanically sealed using heat, e.g. heat sealed. In this embodiment, the first and second peripheries are typically melted together using the heat. Alternatively, the first and second peripheries may be chemically sealed using solvents or bond forming reactions.

The package may also be flushed with air, with an inert gas, or with a combination of air and the inert gas. The inert gas may be any known in the art including, but not limited to, nitrogen, noble gases, and combinations thereof. The package may also include any food suitable polymers known in the art including, but not limited to, polyvinylidene chloride (PVDC). The package may also include one or more additives such as antioxidants and preservatives.

In one embodiment, a polyvinylidene chloride (PVDC) pre printed multilayer laminate is used to form a 5.5″×8.75″ pouch around the trays of paperboard laminated with a polymeric film first described above. In this embodiment, an easy open zipper is also typically added to or bonded to the pouch for consumer convenience. A fin seal is then typically formed using induction seal jaws and the pouch is typically flushed with nitrogen gas before sealing. The fin seal is thought to provide a reliable mechanism for minimizing contamination and for providing an easy-open feature.

### Examples

### Hedonic Scale Evaluation

Two baking compositions (Compositions 1 and 2) are formulated according to the instant invention. A comparative baking composition (Comparative Composition 1) is also formulated but not according to this invention. Comparative Composition 1 is commercially available under the trade name Bob's Red Mill Chocolate Chip Gluten Free. Each of the Compositions 1 and 2 and the Comparative Composition 1 are used to form (i.e., bake) chocolate chip cookies (Cookies 1 and 2 and Comparative Cookies 1, respectively). The Cookies 1 and 2 and Comparative Cookies 1 are of approximately equal size and weight and are baked for approximately the same time. The components of Compositions 1 and 2 are set forth immediately below in Table 1, wherein all parts are in weight percent:

TABLE 1

| | Composition | Composition |
|---|---|---|
| Components | 1 | 2 |
| Quinoa flour | 6.74 | 6.74 |
| White Rice Flour | 5.39 | 5.39 |
| Oat flour | 0.00 | 13.48 |
| Baking Powder (double acting) | 0.54 | 0.54 |
| Salt | 0.27 | 0.27 |
| Xanthan gum | 0.13 | 0.13 |
| Chocolate chips | 13.48 | 13.48 |
| Brown Sugar | 13.48 | 13.48 |
| Table sugar sucrose | 13.48 | 13.48 |
| Vanilla flavor | 0.13 | 0.13 |
| Rolled Oats | 13.48 | 0.00 |
| Shortening | 13.48 | 13.48 |
| Water | 13.48 | 13.48 |
| Total | 100.00 | 100.00 |

After the Cookies 1 and 2 and Comparative Cookies 1 are formed, each is evaluated by 53 panelists in a single blind study to evaluate: aroma, appearance, body texture, flavor, and overall acceptance using a nine point hedonic scale (9=like extremely). The results are set forth in Table 2 below wherein all values represent a numerical mean calculated from the ratings of the 53 panelists. In addition, the P-Value and the statistical Significance are also set forth below.

TABLE 2

| | | | Comparative | | Signifi- |
|---|---|---|---|---|---|
| Components | Cookies 1 | Cookies 2 | Cookies 1 | P-Value | cance |
| Aroma | 7.11a | 6.94a | 6.04b | 0.0001 | Yes |
| Appearance | 6.81 | 6.72 | 7.17 | 0.1870 | No |
| Body Texture | 6.26b | 6.28b | 6.96a | 0.0188 | Yes |
| Flavor | 6.60a | 7.08a | 5.30b | 0.0001 | Yes |
| Overall | 6.58a | 6.92a | 5.75b | 0.0002 | Yes |
| Acceptance | | | | | |

*Values with different letters (a/b) are significantly different from each other

The data set forth immediately above suggest that the Cookies 1 and 2 score significantly higher than the Comparative Cookies 1 in the categories of aroma, flavor, and overall acceptance. The Cookies 1 and 2 score approximately the same as the Comparative Cookies 1 relative to appearance.

Two additional baking compositions (Compositions 3 and 4) are also formulated according to the instant invention. The components of Compositions 3 and 4 are set forth below in Table 3, wherein all parts are in weight percent.

TABLE 3

| | Composition | Composition |
|---|---|---|
| Components | 3 | 4 |
| Quinoa Flour | 6.73 | 6.74 |
| White Rice Flour | 5.61 | 5.62 |
| Corn Starch | 6.17 | 6.18 |
| Oat Flour | 14.02 | 14.04 |
| Salt | 0.42 | 0.42 |
| Chocolate Chips | 11.22 | 11.23 |
| Brown Sugar | 14.02 | 14.04 |
| White Superfine Sugar | 14.02 | 14.04 |
| Vanilla Flavor | 0.28 | 0.28 |
| Xanthan Gum | 0.14 | 0.00 |
| Water | 14.02 | 14.04 |
| Oil | 2.80 | 2.81 |
| Shortening | 9.82 | 9.83 |
| Tocopherols | 0.14 | 0.14 |
| Sodium Aluminum Phosphate (SALP) | 0.28 | 0.28 |
| Sodium Bicarbonate | 0.28 | 0.28 |
| Sodium Benzoate | 0.03 | 0.03 |
| Total | 100.00 | 100.00 |

Each of the Compositions 3 and 4 are used to form (i.e., bake) chocolate chip cookies (Cookies 3 and 4, respectively). The Cookies 3 and 4 are then compared to each other to evaluate texture. More specifically, an additional single blind study is performed wherein 53 panelists evaluate: aroma, appearance, body texture, flavor, and overall acceptance using a nine point hedonic scale (9=like extremely). The results of the comparison of Cookies 3 and 4 compared to themselves are set forth in Table 4 below wherein all values represent a numerical mean calculated from the ratings of the 53 panelists. In addition, the P-Value and the statistical Significance are also set forth below.

TABLE 4

| | Cookies | Cookies | | |
|---|---|---|---|---|
| Components | 3 | 4 | P-Value | Significance |
| Aroma | 6.83 | 6.81 | 0.9128 | No |
| Appearance | 6.51b | 7.21a | 0.0016 | Yes |
| Body Texture | 6.17b | 6.79a | 0.0292 | Yes |
| Flavor | 6.77 | 6.79 | 0.9280 | No |
| Overall Acceptance | 6.60 | 6.86 | 0.2650 | No |

*Values with different letters (a/b) are significantly different from each other

In the categories of Appearance and Body Texture (˜7.2 vs. ˜6.5 and ˜6.2 vs. ˜6.8, p<0.05, respectively) the Cookies 4 show significant improvement over the Cookies 3. Comparison between Cookies 3 and 4 and the Comparative Cookies 1 is made through comparison of the data set forth in Table 4 with the data set forth in Table 2 above wherein the Cookies 3 and 4 generally show improved Aroma, Flavor and Overall Acceptance as compared to the Comparative Cookies 1.

### Nutritional Comparison:

The Cookies 1 are also compared to other comparative cookies (Comparative Cookies 2-7) formed from six comparative baking compositions (Comparative Compositions 2-7). The Comparative Cookies and Formulations are not formed according to this invention. The Comparative Compositions 2-7 are baked according to box directions. The Cookies 1 are prepared according to the method described above.

The Comparative Composition 2 is commercially available from Gordon Foods under the trade name of 365 Chocolate Chip Cookie Mix.

The Comparative Composition 3 is commercially available from Gordon Foods under the trade name of French Meadow Bakery Chocolate Chip Cookie Dough.

The Comparative Composition 4 is commercially available from Gordon Foods under the trade name of Pamela's Products Chocolate Chunk Cookie Mix.

The Comparative Composition 5 is commercially available from Gordon Foods under the trade name of Bob's Red Mill Chocolate Chip Cookies Mix.

The Comparative Composition 6 is commercially available from Nestle, Inc. under the trade name of Toll House Chocolate Chip Cookie Dough Bar.

The Comparative Composition 6 is commercially available from Pillsbury, Inc. under the trade name of Pillsbury Chocolate Chip Cookie Dough.

The Cookies 1 and the Comparative Cookies 2-7 are evaluated to determine nutrition levels using Genesis Software. The results are converted to a 100 g basis and are approximated as follows in Table 5.

TABLE 5
Comparative Nutritional Analysis

| | Serv. Size | | Cals. From | Total Fat | Sat. Fat | Trans Fat | Chol. | Sod. | Carbs | Diet. Fiber | Sugar | Protein |
|---|---|---|---|---|---|---|---|---|---|---|---|---|
| | (g) | Cals. | Fat | (g) | (g) | (g) | (mg) | (mg) | (g) | (g) | (g) | (g) |
| Cookies 1 | 100 | 400 | 150 | 18 | 3 | 0 | 0 | 275 | 60 | 3 | 30 | 5 |
| Comp | 100 | 417 | 139 | 14 | 8 | 0 | 56 | 236 | 69 | 3 | 36 | 3 |
| Cookies 2 | | | | | | | | | | | | |
| Comp | 100 | 514 | 243 | 27 | 12 | 0 | 41 | 405 | 70 | 3 | 22 | 3 |
| Cookies 3 | | | | | | | | | | | | |
| Comp | 100 | 467 | 267 | 27 | 15 | 0 | 83 | 533 | 50 | 0 | 17 | 3 |
| Cookies 4 | | | | | | | | | | | | |
| Comp | 100 | 520 | 180 | 22 | 12 | 0 | 78 | 384 | 82 | 4 | 48 | 4 |
| Cookies 5 | | | | | | | | | | | | |
| Comp | 100 | 480 | 200 | 24 | 12 | 0 | 60 | 360 | 60 | 2 | 40 | 4 |
| Cookies 6 | | | | | | | | | | | | |
| Comp | 100 | 448 | 207 | 24 | 7 | 5 | 17 | 310 | 59 | 3 | 34 | 3 |
| Cookies 7 | | | | | | | | | | | | |

Serv. Size (g) represents an approximate serving size of each Cookie in grams.

Cals represents an approximate total number of calories per 100 grams of each Cookie.

Cals from Fat represents an approximate total number of calories per 100 grams of each Cookie that originate from fat.

Total Fat (g) represents an approximate total number of grams of fat per 100 grams of each Cookie.

Sat. Fat (g) represents an approximate total number of grams of saturated fat per 100 grams of each Cookie.

Trans Fat (g) represents an approximate total number of grams of trans fat per 100 grams of each Cookie.

Chol. (mg) represents an approximate total number of milligrams of cholesterol per 100 grams of each Cookie.

Sod. (mg) represents an approximate total number of milligrams of sodium per 100 grams of each Cookie.

Carbs (g) represents an approximate total number of grams of carbohydrates per 100 grams of each Cookie.

Diet. Fiber (g) represents an approximate total number of grams of dietary fiber per 100 grams of each Cookie.

Sugar (g) represents an approximate total number of grams of sucrose per 100 grams of each Cookie.

Protein (g) represents an approximate total number of grams of protein per 100 grams of each Cookie.

### Summary of Results:

The results set forth above in the various Tables indicate that the instant baking composition and corresponding baked products (i.e., Cookies) surprisingly out-perform various commercially available products relative to hedonic parameters such as aroma, appearance, body texture, flavor, and overall acceptance. In addition, the baking composition and the Cookies out-perform these commercial products while being free of many additional allergens, e.g. being free of the “Big Eight” allergens. This allows many more allergen-sensitive consumers to enjoy these compositions and Cookies. Moreover, the baking composition and the Cookies are approximately as nutritious, if not more so, than many of the commercially available products. This further supports the conclusion that the instant composition and baked products surprisingly out-perform many known products, are more widely accepted by consumers, and can be healthier and more nutritious choices.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

What is claimed is:

1. A baking composition comprising:
A. a flour component; and
B. a binder component,
and comprising less than about 2 parts by weight of each of;
(i) a wheat allergen,
(ii) a nut allergen,
(iii) an egg allergen, and
(iv) a dairy allergen,
per one million parts by weight of said baking composition.

2. A baking composition as set forth in claim 1 that further comprises less than 2 parts by weight of each of:
(v) a seafood allergen;
(vi) a shellfish allergen; and
(vii) a soy allergen,
per one million parts by weight of said baking composition.

3. A baking composition as set forth in claim 2 wherein said flour component is present in an amount of from 15 to 40 parts by weight per 100 parts by weight of said baking composition.

4. A baking composition as set forth in claim 3 wherein said flour component comprises at least two flours selected from the group consisting of oat flour, tapioca flour, quinoa, and rice flour.

5. A baking composition as set forth in claim 4 wherein said flour component comprises 14 to 15 parts by weight of oat or tapioca flour, 6 to 7 parts by weight of quinoa, and 5 to 6 parts by weight of rice flour, per 100 parts by weight of said baking composition.

6. A baking composition as set forth in claim 4 wherein said binder component is present in an amount of from 0.1 to 0.25 parts by weight per 100 parts by weight of said baking composition.

7. A baking composition as set forth in claim 6 further comprising at least one of a fat component, a leavening component, a flavoring component and a sweetener component.

8. A baking composition as set forth in claim 6 further comprising a fat component, a leavening component, a flavoring component and a sweetener component.

9. A baking composition as set forth in claim 8 wherein said fat component is present in an amount of from 5 to 25 parts by weight per 100 parts by weight of said baking composition, said leavening component is present in an amount of from 0.2 to 1.5 parts by weight per 100 parts by weight of said baking composition, said flavoring component is present in an amount of from 0.1 to 2 parts by weight per 100 parts by weight of said baking composition, and said sweetener component is present in an amount of from 10 to 50 parts by weight per 100 parts by weight of said baking composition.

10. A baking composition as set forth in claim 9 that is further defined as a dough and further comprises water present in an amount of from 10 to 20 parts by weight per 100 parts by weight of said dough.

11. A baking composition as set forth in claim 9 that is further defined as a batter and further comprises water present in an amount of at least 20 parts by weight per 100 parts by weight of said batter.

12. A baking composition as set forth in claim 1 that is further defined as a dough and further comprises water present in an amount of from 10 to 20 parts by weight per 100 parts by weight of said dough.

13. A baking composition as set forth in claim 1 that is further defined as a batter and further comprises water present in an amount of at least 20 parts by weight per 100 parts by weight of said batter.

14. A baked product comprising:
A. a flour component; and
B. a binder component,
and comprising less than about 2 parts by weight of each of;
(i) a wheat allergen,
(ii) a nut allergen,
(ii) an egg allergen, and
(iv) a dairy allergen,
per one million parts by weight of said baked product.

15. A baked product as set forth in claim 14 that further comprises less than 2 parts by weight of each of:
(v) a seafood allergen;
(vi) a shellfish allergen; and
(vii) a soy allergen,
per one million parts by weight of said baked product.

16. A baked product as set forth in claim 15 wherein said flour component is present in an amount of from 15 to 40 parts by weight per 100 parts by weight of said baked product.

17. A baked product as set forth in claim 16 wherein said flour component comprises at least two flours selected from the group consisting of oat flour, tapioca flour, quinoa, and rice flour.

18. A baked product as set forth in claim 17 wherein said flour component comprises 14 to 15 parts by weight of oat or tapioca flour, 6 to 7 parts by weight of quinoa, and 5 to 6 parts by weight of rice flour, per 100 parts by weight of said baked product.

19. A baked product as set forth in claim 17 wherein said binder component is present in an amount of from 0.1 to 0.25 parts by weight per 100 parts by weight of said baked product.

20. A baked product as set forth in claim 19 further comprising at least one of a fat component, a leavening component, a flavoring component and a sweetener component.

21. A baked product as set forth in claim 19 further comprising a fat component, a leavening component, a flavoring component and a sweetener component.

22. A baked product as set forth in claim 21 wherein said fat component is present in an amount of from 5 to 25 parts by weight per 100 parts by weight of said baked product, said leavening component is present in an amount of from 0.2 to 1.5 parts by weight per 100 parts by weight of said baked product, said flavoring component is present in an amount of from 0.1 to 2 parts by weight per 100 parts by weight of said baked product, and said sweetener component is present in an amount of from 10 to 50 parts by weight per 100 parts by weight of said baked product.

23. A method of forming a baking composition comprising a flour component, a binder component, and less than about 2 parts by weight of each of a wheat allergen, a nut allergen, an egg allergen, and a dairy allergen, per one million parts by weight of the baking composition, said method comprising the steps of:
A. providing the flour component;
B. providing the binder component; and
C. combining the flour and binder components to form the baking composition.

24. A method as set forth in claim 23 wherein the baking composition further comprises a sweetener component and said method further comprises the step of incorporating the sweetener component into the binder component before said step of combining the flour and binder components.

25. A method as set forth in claim 23 wherein the baking composition further comprises an antioxidant component and said method further comprises the step of incorporating the antioxidant component into the binder component before said step of combining the flour and binder components.

26. A method as set forth in claim 23 wherein the flour component comprises quinoa flour and said method further comprises the step of roasting the quinoa flour.

27. A method as set forth in claim 26 wherein the quinoa flour comprises particles having a thickness of from 1 to 3 mm and wherein said step of roasting occurs for a time of from 10 to 25 minutes at a temperature of from 250 to 350° F.
